(19) United States
(12) Patent Application Publication
(10) Pub. No.: US 2017/0212896 A1
(43) Pub. Date: Jul. 27, 2017

(54) METHOD FOR EXTRACTING CHARACTER STRING CANDIDATE, CHARACTER STRING CANDIDATE EXTRACTION APPARATUS, AND NON-TRANSITORY RECORDING MEDIUM STORING CHARACTER STRING CANDIDATE EXTRACTION PROGRAM

(71) Applicant: FUJITSU LIMITED, Kawasaki-shi (JP)

(72) Inventor: Tomoya Iwakura, Kawasaki (JP)

(73) Assignee: FUJITSU LIMITED, Kawasaki-shi (JP)

(21) Appl. No.: 15/401,192

(22) Filed: Jan. 9, 2017

(30) Foreign Application Priority Data
Jan. 21, 2016 (JP) 2016-009901

(51) Int. Cl. G06F 17/30; G06F 17/27

(52) U.S. Cl. CPC G06F 17/3043; G06F 17/2705; G06F 17/2765

(57) ABSTRACT

A method for extracting character string candidate includes: receiving, by a computer, an input character or an input character string, and input identity information of an input source of the input character or the input character string; referencing a memory that stores character string candidates in association with pronunciation and identification information or the identification information; extracting, from among the character string candidates, a character string candidate that is associated with the input identity information and the pronunciation including the input character or the input character string, or a character string candidate that is associated with the input identity information and a character or a character string including the input character or the input character string; and outputting an extracted character string candidate as a selection candidate.

### CROSS-REFERENCE TO RELATED APPLICATION

This application is based upon and claims the benefit of priority of the prior Japanese Patent Application No. 2016-009901, filed on Jan. 21, 2016, the entire contents of which are incorporated herein by reference.

### FIELD

The embodiment discussed herein is related to a method for extracting character string candidate, a character string candidate extraction apparatus, and a non-transitory recording medium storing a character string candidate extraction program.

### BACKGROUND

A search term is input to search for desired information via the Internet, a database, or the like.

Related art is disclosed in Japanese Laid-open Patent Publication Nos. 2010-211075, 2008-158949, and 2011-053866.

### SUMMARY

According to an aspect of the embodiments, a method for extracting character string candidate includes: receiving, by a computer, an input character or an input character string, and input identity information of an input source of the input character or the input character string; referencing a memory that stores character string candidates in association with pronunciation and identification information or the identification information; extracting, from among the character string candidates, a character string candidate that is associated with the input identity information and the pronunciation including the input character or the input character string, or a character string candidate that is associated with the input identity information and a character or a character string including the input character or the input character string; and outputting an extracted character string candidate as a selection candidate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of an information processing system;

FIG. 2 illustrates a software configuration of a document management apparatus;

FIG. 3 illustrates an example of a functional configuration of the document management apparatus;

FIG. 4 illustrates a search process of a document record;

FIG. 5 illustrates an example of a user database (DB);

FIG. 6 illustrates a character string candidate DB;

FIG. 7 illustrates an identification process of a user who is able to recommend a search term;

FIG. 8 illustrates an example of a structure of a recommended destination determination DB;

FIG. 9 illustrates an example of an updated character string candidate DB; and

FIG. 10 illustrates a structure of the character string candidate DB.

### DESCRIPTION OF EMBODIMENTS

If part of the pronunciation (syllable) of a search term is input to assist the searching of the search term, a search term responsive to the input pronunciation is extracted from the log of past search terms. A list of extracted search terms is provided as input candidates.

As the number of input candidates presented increases, it is more likely that the search term the user desires to input is included in the input candidates, and the assistance to the user to input the search term becomes greater. To this end, the logs of search terms input by multiple users may be shared.

If the logs of the search terms are shared, a search term including confidential information which a particular user only is permitted to access may mix into the search terms, and the confidential information may leak to a user other than the particular user.

The log of the search terms may now be shared in a company. If a user at a management level inputs a search term “electronic division reorganization”, this search term may be included in the log of the search terms. If a general staff member inputs “electronic” to input a search term “electronic component”, the term “electronic division reorganization” is presented as an input candidate. For this reason, the fact that the reorganization of the electronic division is currently under study may be leaked to the general staff member.

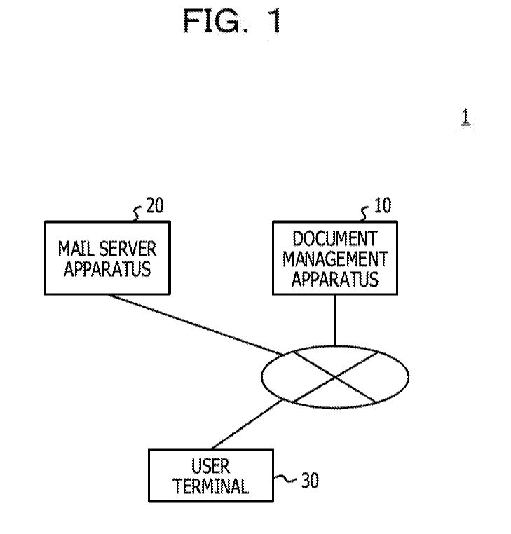

FIG. 1 illustrates an information processing system 1. The information processing system 1 may be run by a certain company (hereinafter referred to as “company X”). Referring to FIG. 1, the information processing system 1 includes a document management apparatus 10, a mail server apparatus 20, and one or more user terminals 30. The document management apparatus 10, the mail server apparatus 20, and each user terminal 30 are connected via a network, such as a local area network (LAN) in the company X or a wide area network (WAN).

The document management apparatus 10, including a database that registers a record related to a document (hereinafter referred to as a “document record”), may be a computer that searches the database for the document record. The document management apparatus 10 may include multiple computers. During the search of the document record, the document management apparatus 10 performs an operation to assist a user to input a search term. The operation to assist the user to input the search term is to output a list of character strings (hereinafter referred to as a “character string candidate”) that are considered to be input candidates, in response to the inputting of part of the pronunciation of the search term.

The mail server apparatus 20 may be a computer that functions as a mail server of electronic mails. For example, an outgoing mail from each user terminal 30 and an incoming mail to each user terminal 30 may be stored on the mail server apparatus 20.

The user terminal 30 may be a terminal, such as a personal computer (PC) that is used by a user of the information processing system 1 (such as an employee of company X). A portable terminal, such as a tablet terminal or a smart phone, may be used for the user terminal 30. The user terminal 30 may operate as a user interface that searches for the document record.

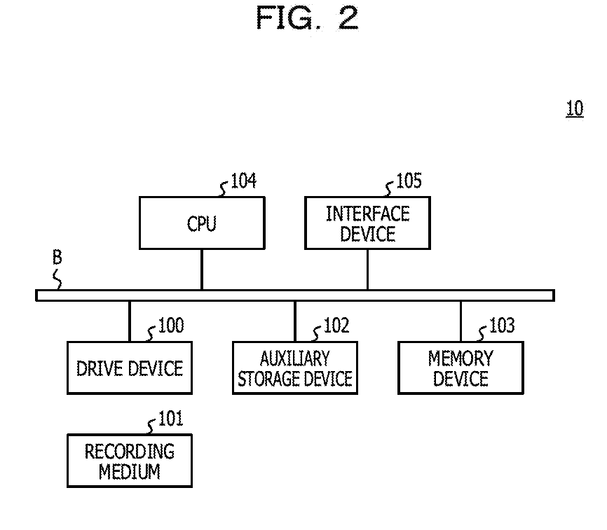

FIG. 2 illustrates a hardware configuration of the document management apparatus 10. The document management apparatus 10 of FIG. 2 includes a drive device 100, an auxiliary storage device 102, a memory device 103, a central processing unit (CPU) 104, an interface device 105, and the like.

The program to be executed by the document management apparatus 10 may be provided via a recording medium 101. With the recording medium 101 having the program recorded thereon set in the drive device 100, the program is installed from the recording medium 101 to the auxiliary storage device 102 via the drive device 100. The program is not necessarily installed via the recording medium 101. The program may be downloaded via a network from another computer. The auxiliary storage device 102 stores the installed program while also storing files, data, and the like.

The memory device 103 reads the program from the auxiliary storage device 102 and stores the program thereon in response to a startup command of the program. The CPU 104 performs a function related to the document management apparatus 10 in accordance with the program stored on the memory device 103. The interface device 105 may be used as an interface for connection with the network.

An example of the recording medium 101 is a portable recording medium, such as compact-disk ROM, a digital versatile disk (DVD), or a universal serial bus (USB) memory. An example of the auxiliary storage device 102 is a hard disk drive (HDD) or a flash memory. Each of the recording medium 101 and the auxiliary storage device 102 may be a computer-readable recording medium.

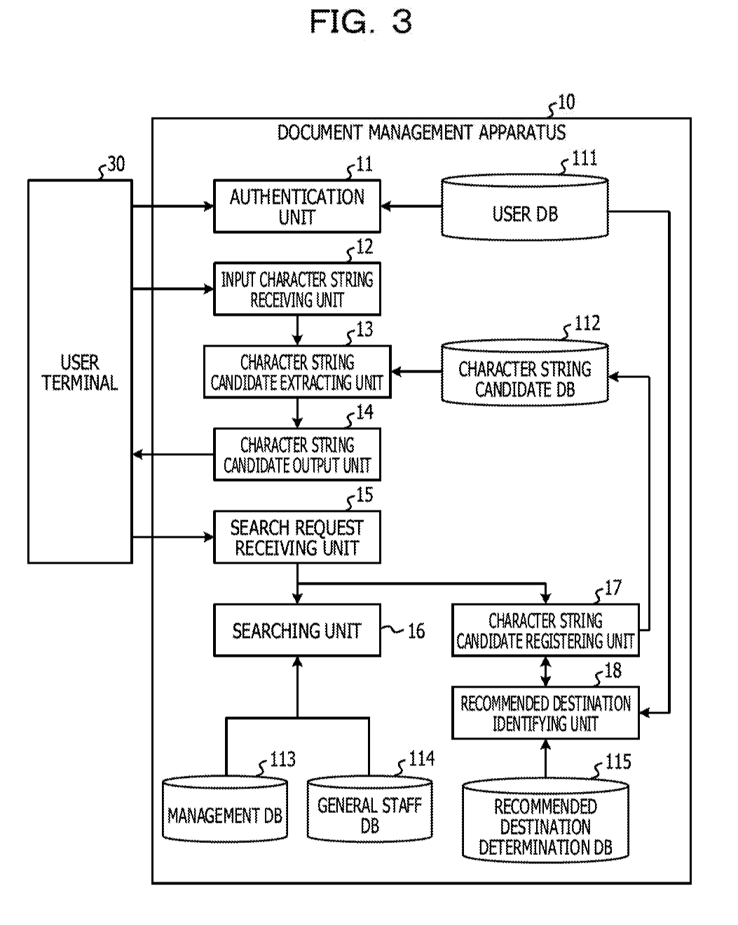

FIG. 3 illustrates an example of a functional configuration of the document management apparatus 10. Referring to FIG. 3, the document management apparatus 10 includes an authentication unit 11, an input character string receiving unit 12, a character string candidate extracting unit 13, a character string candidate output unit 14, a search request receiving unit 15, a searching unit 16, a character string candidate registering unit 17, and a recommended destination identifying unit 18. These elements are implemented when the CPU 104 executes one or more programs installed on the document management apparatus 10. The document management apparatus 10 uses databases (memory units), including a user DB 111, a character string candidate DB 112, a management DB 113, a general staff DB 114, and a recommended destination determination DB 115. Each of these databases may be implemented using a storage device that is connectable to the auxiliary storage device 102 or the document management apparatus 10 via the network.

The authentication unit 11 authenticates the user of the document management apparatus 10 by referencing the user DB 111. Through the user authentication, identify information of the user (user ID) is confirmed. The user DB 111 stores the user ID, the password, and the attribute information of the user on a per user basis.

The input character string receiving unit 12 receives a character string input to a search term input column from the user terminal 30 each time each character is input in the search term input column of a search screen displayed on the user terminal 30. For convenience of explanation, one character may also be referred to as a character string.

The character string candidate extracting unit 13 extracts a character string candidate from the character string candidate DB 112 in accordance with the character string received by the input character string receiving unit 12 (hereinafter referred to as an “input character string”) and a user ID identified by the authentication unit 11. The character string candidate DB 112 stores each character string candidate, the pronunciation thereof, and the user ID of the user who is able to recommend (who is able to present) the character string candidate in association with each other. For example, the character string candidate extracting unit 13 extracts from the character string candidate DB 112 the character string candidate that is associated with the pronunciation of the input character string, or the character string candidate that includes the input character string, and is associated with the user ID identified by the authentication unit 11.

The character string candidate output unit 14 outputs a list of character string candidates extracted by the character string candidate extracting unit 13 as selection candidates. The character string candidate output unit 14 transmits the list of character string candidates to the user terminal 30 as a transmission source of the input character string.

The search request receiving unit 15 receives a search request of the document record transmitted from the user terminal 30. The search request includes the search term as a character string that is finalized as an input.

The searching unit 16 searches the general staff DB 114 or both the general staff DB 114 and the management DB 113 for the document record according to the search term included in the search request. If the user as a search request source is a general staff member, the searching unit 16 searches the general staff DB 114 for the document record. If the user as a search request source is at a management level, the searching unit 16 searches both the general staff DB 114 and the management DB 113 for the document record. The management DB 113 stores the document records which only the user at the management level is permitted to access. The general staff DB 114 stores the document records which both the user at the management level and the user at the general staff level are permitted to access.

The character string candidate registering unit 17 registers the search term included in the search request as a character string candidate on the character string candidate DB 112. The recommended destination identifying unit 18 identifies the user who is able to recommend (present) a character string candidate related to the search term included in the search request. For example, the user who gains access to document data including the search term (who is permitted to reference the document data) is identified as a user who is able to recommend the character string candidate related to the search term. The “document data” indicates digital data including a character string, and has broader sense than the document record. For example, the document data may include a document record, an electronic mail, and a document file stored on each the user terminal 30.

The recommended destination determination DB 115 stores information that is involved in determining a user who is able to recommend a character string candidate.

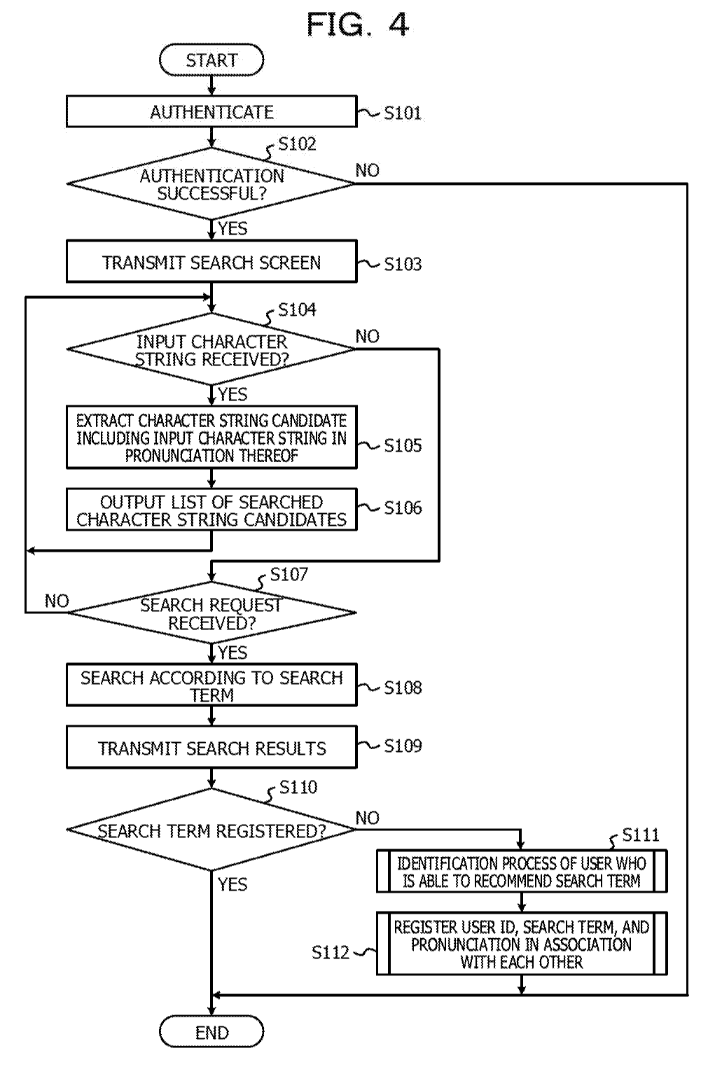

FIG. 4 illustrates a search process of a document record.

Upon receiving a log-in request from the user terminal 30, the authentication unit 11 authenticates the user in accordance with a user ID and a password included in the log-in request and the user DB 111 (S101).

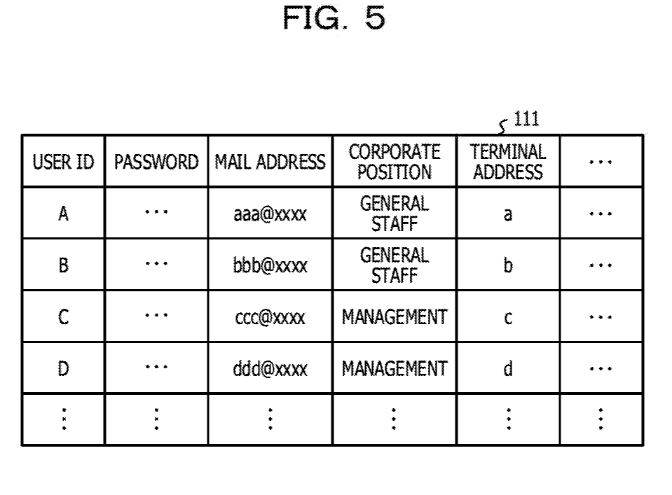

FIG. 5 illustrates an example of the user DB 111. As illustrated in FIG. 5, the user DB 111 stores user IDs, passwords, mail addresses, corporate positions, and terminal addresses.

The user ID is information identifying each user in the document management apparatus 10. The password corresponds to the user ID. The mail address is a mail address of the user. The corporate position is that of the user. For example, the corporate position may be divided into a “management level” and a “general staff level”. The terminal address is address information of the user terminal 30 used by the user, such as an Internet protocol (IP) address.

In operation S101, if a record including a set of a user ID and password included in the log-in request is stored on the user DB 111, the authentication operation is successful. If the record is not stored on the user DB 111, the authentication operation is not successful. If the authentication operation is not successful (no branch from S102), subsequent operations are not performed.

If the authentication operation is successful (yes branch from S102), the authentication unit 11 transmits the document data on a search screen to the user terminal 30 (S103). The search screen is then displayed on the user terminal 30. The search screen includes a search term input column, and a button configured to receive an execution command of a search, for example.

If the authentication operation is successful, the user ID included in the log-in request is stored as the user ID of a log-in user (hereinafter referred to as a “log-in user ID”) on the memory device 103 in the document management apparatus 10. A session ID is assigned to the log-in user ID. The session ID is associated with the log-in user ID and then stored on the memory device 103. The session ID is transmitted together with display data on the search screen to the user terminal 30. Information to be transmitted to the user terminal 30 thereafter includes the session ID. The log-in user ID may be used as a session ID.

The input character string receiving unit 12 waits on standby to receive the input character string (S104). Each time characters are input one by one in the search term input column on the search screen, the user terminal 30 transmits the input character string including all input characters input to the search term input column to the document management apparatus 10.

When the input character string receiving unit 12 receives the input character string (yes branch from S104), the character string candidate extracting unit 13 extracts from the character string candidate DB 112 the character string candidate associated with the pronunciation including the input character string, or the character string candidate including the input character string and associated with the log-in user ID (S105).

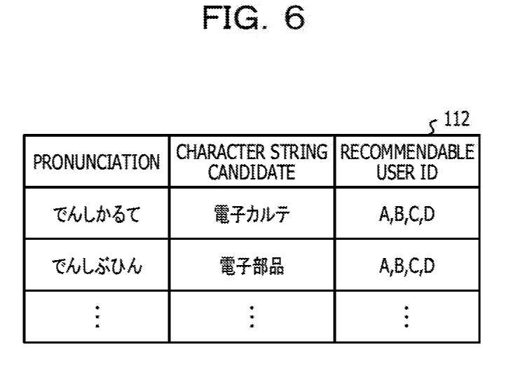

FIG. 6 illustrates an example of the character string candidate DB 112. Referring to FIG. 6, each record in the character string candidate DB 112 includes a pronunciation (syllable), a character string candidate, and a recommendable user ID.

The pronunciation is a pronunciation of the character string candidate. The recommendable user ID is a user ID of a user who is able to recommend the character string candidate. In FIG. 6, for example, the pronunciations of Japanese are associated with the respective Japanese character string candidates including Chinese character (kanji).

In operation S105, the character string candidate extracting unit 13 may extract from the character string candidate DB 112 a character string candidate associated with the pronunciation forward matched to the input character string, or a character string candidate that is forward matched to the input character string and associated with the log-in user ID. If the input character string is “electronic”, and the log-in user ID is “A”, the terms “electronic medical record”, “electronic component”, and the like are extracted. If the input character string is “electronic medical”, and the log-in user ID is “A”, the term “electronic medical record” and the like are extracted.

The log-in user ID may be identified in accordance with a session ID received together with the input character string. The session ID is associated with the user ID. It is thus understood that the user ID is input together with the input character string.

The user ID associated with a transmission source address of a packet including information transmitted from the user terminal 30 is identified, and the character string candidate associated with the transmission source address and the user ID may be handled as an extraction candidate. In this case, the user identification operation is not performed. The user ID associated with the transmission source address may be a user ID associated with a terminal address matching the transmission source address on the user DB 111.

In operation S105, only the character string candidate associated with both the pronunciation including the input character string and the log-in user ID may be extracted. For example, the character string candidate extracting unit 13 is free from determining whether the character string candidate includes the input character string.

The character string candidate output unit 14 transmits the user terminal 30 a list of extracted character string candidates as selection candidates (S106). The user terminal 30 displays each character string candidate in the list in a ready-to-be-selected state. Operations S104 through S106 are repeated each time the pronunciation of one character of the search term is input. As a result, the character string candidates presented to the user are gradually narrowed.

If a search command is input after the search term is finalized by selecting one of the character string candidates displayed on the user terminal 30 or the search term is finalized by inputting a character string without selecting any character string candidate, the user terminal 30 transmits to the document management apparatus 10 a search request including the search term (hereinafter referred to as a “target search term”).

If the search request receiving unit 15 in the document management apparatus 10 receives the search request (yes branch from S107), the searching unit 16 searches the general staff DB 114 or both the management DB 113 and the general staff DB 114 for a document record related to a document including the target search term (S108). If the corporate position associated with the log-in user ID stored on the user DB 111 is a “general staff level”, the searching unit 16 searches the general staff DB 114 for the document record. If the corporate position associated with the log-in user ID stored on the user DB 111 is a “management level”, the searching unit 16 searches the management DB 113 and the general staff DB 114 for the document record.

The searching unit 16 transmits a list of hit document records to the user terminal 30 (S109).

The character string candidate registering unit 17 determines whether the target search term is stored as a character string candidate on the character string candidate DB 112 (S110). For example, the character string candidate registering unit 17 determines whether a record including the character string candidate fully matching the target search term is stored on the character string candidate DB 112.

If the target search term is not stored as a character string candidate on the character string candidate DB 112 (no branch from S110), the recommended destination identifying unit 18 identifies a user ID who is able to recommend the target search term as a character string candidate (S111). The character string candidate registering unit 17 stores on the character string candidate DB 112 the target search term, the pronunciation of the target search term, the user ID identified in operation S111, and the user ID responsive to the search request in association with each other (S112). For example, the character string candidate DB 112 stores a record including the character string candidate as the target search term, the pronunciation of the character string candidate as the pronunciation of the target search term, and the user ID identified in operation S111 and the user ID related to the search request, each serving as the recommendable user ID. The user ID related to the search request refers to a log-in user ID associated with the session ID included in the search request. The user who has input the search term is automatically included in users who are able to recommend the search term.

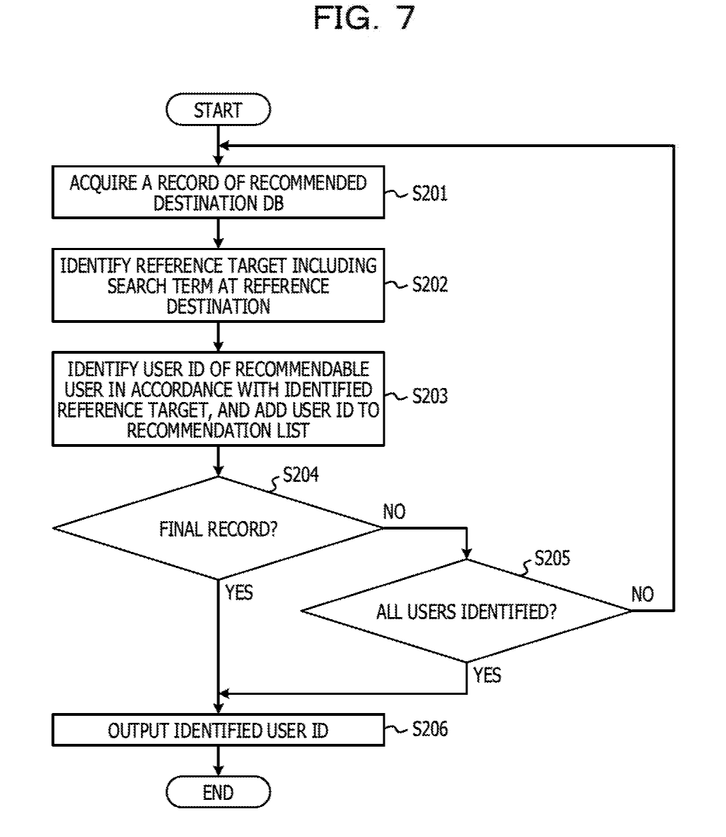

FIG. 7 illustrates an identification process of the user who is able to recommend a search term.

In operation S201, the recommended destination identifying unit 18 acquires an unprocessed record at the top of the recommended destination determination DB 115. The acquired record may be referred to as a “target record” in the following discussion.

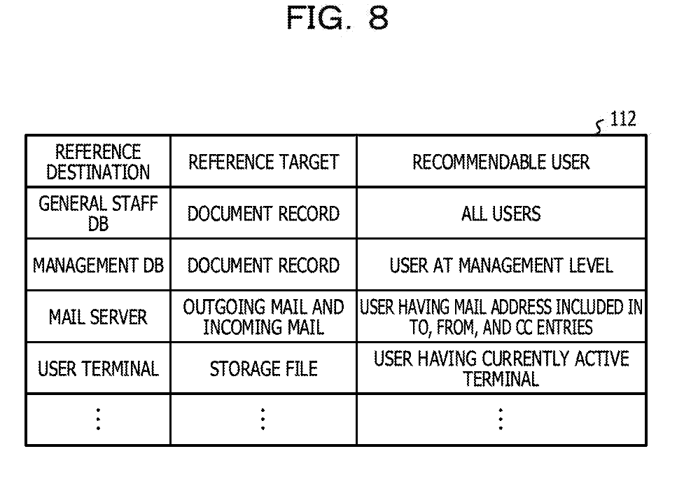

FIG. 8 illustrates an example of a structure of the recommended destination determination DB 115. As illustrated in FIG. 8, each record of the recommended destination determination DB 115 includes column headings of a reference destination, a reference target, and a recommendable user.

The reference destination is identification information of a database or a computer, serving as a reference destination, and is used to identify a user who is able to recommend a target search term. At the reference destination, the reference target is identification information of the document data that is an access target as to whether the reference target includes the target search term. The recommendable user is information indicating a user who is able to recommend the target search term if the reference target includes the target search term. The user ID associated with the reference target including the target search term is the user ID of a user who is able to recommend the target search term.

The recommended destination identifying unit 18 accesses the reference destination of a target record and identifies the reference target including the target search term from among the reference targets stored on the reference destination (S202). If a first record is the target record, the document record including the target search term is searched for from among the document records of the general staff DB 114. If a second record is the target record, the document record including the target search term is searched for from among the document records of the management DB 113. If a third record is the target record, an electronic mail including the target search term is searched from among outgoing mails and incoming mails stored on the mail server apparatus 20. If a fourth record is the target record, a file including the target search term is searched for from among files stored on the user terminal 30. The reference target including the target search term is a reference target including a character string fully matching the target search term. If the target search term includes multiple words, a reference target including all the words forming the target search term may be the reference target including the target search term. In such a case, the words in the reference target do not necessarily have to appear in the order of appearance in the target search term.

The recommended destination identifying unit 18 identifies the user ID of the user who is able to recommend the target search term in accordance with the identified reference target and adds the identified user ID to a recommendation list (S203). The recommendation list stores a set of user IDs of users who are able to recommend target search terms. When the process of FIG. 7 starts, the recommendation list may be empty in value. The addition of the user ID to the recommendation list is performed by removing redundancy. For example, if a user ID “A” is included in the recommendation list, the addition of the user ID “A” is not performed.

If the first record is the target record, and the search term is included in a document record of the general staff DB 114, all user IDs registered on the user DB 111 are identified as the user IDs. If the second record is the target record, and the search term is included in a document record of the management DB 113, a user ID of a user at the “management level” is identified as the user ID from among the user IDs registered on the user DB 111. If the third record is the target record, a user ID whose mail address is associated with a destination (To), a sender (From), or a carbon copy (CC) of an electronic mail including the search term, from among the user IDs stored on the user DB 111, is identified as the user ID. If the fourth record is the target record, a user ID associated with the terminal address of the user terminal 30 serving as a storage destination of the file including the search term, from among the user IDs registered on the authentication unit 11, is identified as the user ID.

FIG. 8 illustrates an example of registration contents of the recommended destination determination DB 115. The recommendable user associated with the reference destination and the reference target may have a different setting from FIG. 8. A reference destination and a reference target not illustrated in FIG. 8 may also be set.

The recommended destination identifying unit 18 determines whether the target record is the final record of the recommended destination determination DB 115 (S204). If the target record is not the final record (no branch from S204), the recommended destination identifying unit 18 determines whether all user IDs registered on the user DB 111 are included in the recommendation list (S205). All user IDs are not included in the recommendation list (no branch from S205), operation S201 and subsequent operations are repeated. In this case, a record subsequent to the target record is a new target record.

If the target record is the final record (yes branch from S204), or all user IDs are included in the recommendation list (yes branch from S205), the recommended destination identifying unit 18 outputs a set of user IDs included in the recommendation list (S206).

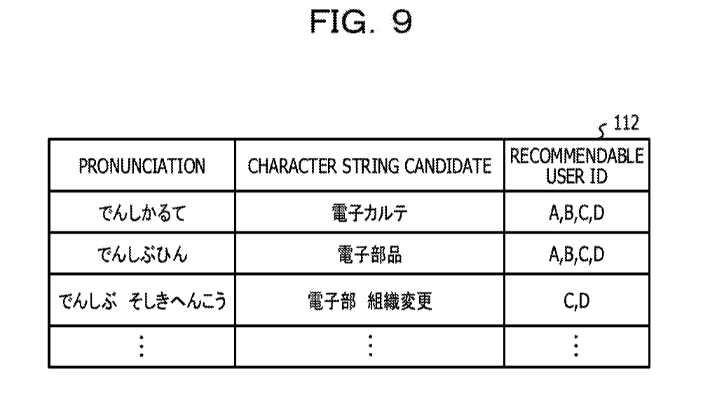

A user C at the management level having a user ID “C” may now input a search term “electronic division reorganization”. In this case, the user C having input the search term is determined to be a recommendable user. If the search term “electronic division reorganization” is not included in any document record of the general staff DB 114 but included in a document record of the management DB 113, a user D at the management level is determined to be a recommendable user. As a result, the character string candidate DB 112 of FIG. 6 is updated in operation S112 of FIG. 4 as illustrated in FIG. 9.

FIG. 9 illustrates an example of the updated character string candidate DB 112. In FIG. 9, for example, the pronunciations of Japanese are associated with the respective Japanese character string candidates including Chinese character (kanji).

Referring to FIG. 9, a record having “electronic division reorganization” is newly added as a character string candidate. The recommendable user IDs of the record includes “C” and “D”.

Even if user A or B inputs character string “electron”, “electronic”, or “electronic division”, “electronic division reorganization” is not displayed as a character string candidate. For example, if user C or D inputs the character string “electron”, “electronic”, or “electronic division”, “electronic division reorganization” is displayed as a character string candidate.

If it is determined in operation S110 of FIG. 4 that the target search term is not stored on the character string candidate DB 112, the process of FIG. 7 may be performed. Also, the process of FIG. 7 may be performed regardless of whether the target search term is stored on the character string candidate DB 112. This is because if the user ID registered on the user DB 111 is changed, or the contents of the recommended destination determination DB 115 are changed, the user who is able to recommend a registered character string candidate may change to a different person.

Operation S110 and subsequent operations of FIG. 4 may be performed in synchronization with each other subsequent to operation S109. For example, with the target search term stored, operation S110 and subsequent operations may be performed at a predetermined timing.

As described above, each character string candidate is associated with the user ID of the user who is able to recommend the character string candidate (who is permitted to reference the character string candidate), and is then stored on the character string candidate DB 112. When an input character string is received, a character string candidate that is associated with the pronunciation of the input character string, or a character string candidate that includes the input character string and is associated with the user ID associated with the input source of the input character string is output as a selection candidate. For this reason, the character string candidates excluding the character string candidate associated with the input source of the input character string are displayed in a reduced number. As a result, the possibility of information leakage caused by the presentation of the input candidates (the character string candidates) may be reduced.

When a search term is registered as a character string candidate, the user ID of a user who gains access to the document data including the search term is associated with the character string candidate. After a new character string candidate is registered, the possibility of information leakage caused by presenting an input candidate (a character string candidate) may be reduced.

Each user terminal 30 may include the input character string receiving unit 12, the character string candidate extracting unit 13, the character string candidate output unit 14, the character string candidate registering unit 17, and the recommended destination identifying unit 18. In such a case, operations S103 through S106, and S110 through S112 of FIG. 4 may be performed by each user terminal 30.

The exemplary embodiment may be also applicable to applications other than inputting the search term. For example, if a dictionary of example sentences is shared by multiple users, the exemplary embodiment is applicable. In such a case, an example sentence is a character string candidate, and may be associated with a user ID before being stored on the dictionary.

The exemplary embodiment may be applicable to proofreading of a sentence using a log. In the proofreading of a sentence using the log, a sentence revise pattern is obtained from a past rewritten history, and a sentence is revised in accordance with the revise pattern. The revise pattern may be associated with a user ID and then stored.

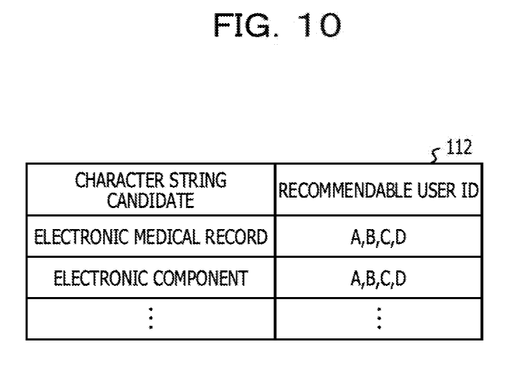

FIG. 10 illustrates a structure of the character string candidate DB 112. The character string candidate DB 112 of FIG. 10 may be the character string candidate DB 112 of FIG. 3. Unless otherwise particularly noted, configurations identical or similar to the configurations illustrated in FIG. 1 through FIG. 9 are also applicable herein. Referring to FIG. 10, the character string candidate DB 112 does not include the record for pronunciation.

Each time a character string input to the search term input column of the search screen is finalized, the user terminal 30 transmits the input character string to the document management apparatus 10. For example, if pronunciation “elec” is converted into and then finalized as “electronic”, the user terminal 30 transmits “electronic” to the document management apparatus 10.

In operation S105 of FIG. 4, the character string candidate extracting unit 13 in the document management apparatus 10 extracts from the character string candidate DB 112 a character string candidate including the input character string (for example, forward matched to the input character string), and associated with the user ID related to the input character string.

In operation S112 of FIG. 7, the character string candidate registering unit 17 stores on the character string candidate DB 112 a record that includes a target search term including a character string candidate and a user ID included in the recommendation list as a recommendable user ID.

Even if the character string candidate is not related to the pronunciation thereof as illustrated in FIG. 10, effects similar to those of the configurations of FIG. 1 through FIG. 9 may be obtained.

The character string candidate may be collected from the log of search terms.

The document management apparatus 10 may be an example of a character string candidate extracting apparatus. The log-in user ID may be an example of identity information of the input source. The character string candidate DB 112 may be an example of the memory. The search term may be an example of a character string that is finalized by inputting. The character string candidate extracting unit 13 may be an example of an extractor. The character string candidate output unit 14 may be an example of an output unit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method for extracting character string candidate comprising:
receiving, by a computer, an input character or an input character string, and input identity information of an input source of the input character or the input character string;
referencing a memory that stores character string candidates in association with pronunciation and identification information or the identification information;
extracting, from among the character string candidates, a character string candidate that is associated with the input identity information and the pronunciation including the input character or the input character string, or a character string candidate that is associated with the input identity information and a character or a character string including the input character or the input character string; and
outputting an extracted character string candidate as a selection candidate.

2. The method according to claim 1, wherein the identification information associated with the respective character string candidates in the memory is associated with document data including the character string candidate.

3. The method according to claim 1, further comprising:
receiving a definite character or a definite character string which is obtained by confirming an input of the input character or the input character string;
identifying document data including the definite character or the definite character string; and
storing, in the memory, the identification information associated with the document data and the definite character or the definite character string which are associated with each other.

4. The method according to claim 1, wherein one or more databases are searched based on a search term that is confirmed by determining the selection candidate.

5. The method according to claim 4, wherein the one or more databases are classified according to the identification information.

6. A character string candidate extraction apparatus, comprising:
a memory that stores a program; and
a processer that executes the program,
wherein the processor, based on the program, performs operations of:
receiving an input character or an input character string, and input identity information of an input source of the input character or the input character string;
referencing the memory that stores character string candidates in association with pronunciation and identification information or the identification information;
extracting, from among the character string candidates, a character string candidate that is associated with the input identity information and the pronunciation including the input character or the input character string, or a character string candidate that is associated with the input identity information and a character or a character string including the input character or the input character string; and
outputting an extracted character string candidate as a selection candidate.

7. The character string candidate extraction apparatus according to claim 6, wherein the identification information associated with the respective character string candidates in the memory is associated with document data including the character string candidate.

8. The character string candidate extraction apparatus according to claim 6, wherein the processor:
receives a definite character or a definite character string which is obtained by confirming an input of the input character or the input character string;
identifies document data including the definite character or the definite character string; and
stores, in the memory, the identification information associated with the document data and the definite character or the definite character string which are associated with each other.

9. The character string candidate extraction apparatus according to claim 6, wherein one or more databases are searched based on a search term that is confirmed by determining the selection candidate.

10. The character string candidate extraction apparatus according to claim 9, wherein the one or more databases are classified according to the identification information.

11. A non-transitory recording medium storing a character string candidate extraction program which causes a computer to perform operations, the operations comprising:
receiving an input character or an input character string, and input identity information of an input source of the input character or the input character string;
referencing a memory that stores character string candidates in association with pronunciation and identification information or the identification information;
extracting, from among the character string candidates, a character string candidate that is associated with the input identity information and the pronunciation including the input character or the input character string, or a character string candidate that is associated with the input identity information and a character or a character string including the input character or the input character string; and
outputting an extracted character string candidate as a selection candidate.

12. The non-transitory recording medium according to claim 11, wherein the identification information associated with the respective character string candidates in the memory is associated with document data including the character string candidate.

13. The non-transitory recording medium according to claim 11, further comprising:
receiving a definite character or a definite character string which is obtained by confirming an input of the input character or the input character string;
identifying document data including the definite character or the definite character string; and
storing, in the memory, the identification information associated with the document data and the definite character or the definite character string which are associated with each other.

14. The non-transitory recording medium according to claim 11, wherein one or more databases are searched based on a search term that is confirmed by determining the selection candidate.

15. The non-transitory recording medium according to claim 14, wherein the one or more databases are classified according to the identification information.
